(19) United States
(12) Patent Application Publication
(10) Pub. No.: US 2018/0218411 A1
(43) Pub. Date: Aug. 2, 2018

(54) SYSTEMS AND METHODS FOR ONLINE ADVERTISING

(71) Applicant: GARY FANG, Inglewood, CA (US)

(72) Inventor: GARY FANG, Inglewood, CA (US)

(21) Appl. No.: 15/939,580

(22) Filed: Mar. 29, 2018

(51) Int. Cl. G06Q 30/02; H04W 48/18

(52) U.S. Cl. CPC G06Q 30/0275; H04W 76/10; G06Q 30/0277; H04W 48/18

(57) ABSTRACT

A method for online advertising comprising: receiving a request from wireless network providers for offering an access of wireless networks as a service, the wireless network comprises a Service Set Identifier (SSID); receiving an advertising request from advertisers for advertising a service and/or a product to users; receiving a selection of the at least one SSID from a user for connecting to the at least one wireless network; receiving a payment from the advertisers for advertising; making another payment to the wireless network providers; associating an SSID with each of the advertisers; and presenting a multimedia along with a connect option on a computing device of the user based on the selection of the at least one SSID associated with the at least one wireless network and the at least one advertiser.

### TECHNICAL FIELD

The presently disclosed subject matter generally relates to the Internet technologies. Particularly, the present subject matter relates to systems and methods for online advertising by playing a multimedia when a user request to access a wireless network by selecting a Service Set Identifier (SSID) of the wireless network, the wireless network may be owned by a wireless network provider.

### BACKGROUND

Millions of users connect to the Internet on daily basis for sharing, and gaining knowledge, for shopping, for entertainment, for business, and so forth. The Internet is a web of multiple network comprising wired and wireless networks. Each of the wired and wireless networks may further include a plurality of computing or electronic devices such as routers, modems, servers, gateways, client devices, and so forth. Communication technologies that can link multiple communication/electronic devices in a networked fashion are well known. Examples of communication networks may include, but are not limited to, wired packet data networks, wireless packet data networks, wired telephone networks, wireless telephone networks, and satellite communication networks, among other networks. These communication networks may enable client devices to communicate with each other on a global basis. Wired Local Area Networks (LANs), e.g., Ethernets are also quite common and support communications between networked computers and other devices within an area. The LANs may link serviced devices to Wide Area Networks and the Internet. Each of these networks is generally considered a “wired” network, even though some of these networks, e.g., the PSTN, may include some transmission paths that are serviced through wireless links/wireless networks.

Wireless networks such as, but not limited to, cellular telephone networks, wireless LANs (WLANs), and satellite communication networks are extensively used these days by millions of users all over the world on daily basis. Users like to be connected to the WLANs while on the go and almost always. Example of the WLANs may include, but are not limited to, IEEE 802.11(a) networks, IEEE 802.11(b) networks, and IEEE 802.11(g) networks, referred to jointly as “IEEE 802.11 networks.” WLANs provide significant advantages when servicing portable devices such as portable computers, portable data terminals, mobile devices, and other devices that are not typically stationary.

Many service providers provide free access to wireless networks to users in places like, restaurants, airports, movie halls, auditoriums, offices, homes, and so forth. Some wireless networks are password protected and some may provide access for free but in exchange of user's personal information. The users cannot proceed exploring Internet without surrendering their personal information, which makes their personal information vulnerable. Therefore, the users have to surrender their personal identity information for accessing free wireless networks.

### SUMMARY

In light of above discussion, there exists need for improved techniques for enabling various wireless network owners to share their wireless network with other users for earning some benefits. The present disclosure provides an online platform for online advertising when a user selects a selection of a Service Set Identifier (SSID) of a wireless network for connecting to the wireless network.

The present disclosure provides systems and methods for online advertising by playing a multimedia when a user requests access to a wireless network by selecting a Service Set Identifier (SSID) of the wireless network. A wireless network provider may own the wireless network. The multimedia may be an advertisement of an advertiser. The advertiser may be an individual or a company. For example, the advertiser may be a restaurant.

The present disclosure provides an online platform for online advertising by a plurality of advertisers. The online platform also enables various wireless network providers to offer their wireless network to other users.

The present disclosure provides systems and methods for providing a bidding platform to a plurality of wireless network providers and a plurality of advertisers for negotiating one or more conditions for advertising using wireless networks of the wireless network providers. The plurality of wireless network providers may own at least one wireless network.

The present disclosure provides systems and methods for offering wireless networks as a service by a plurality of wireless network providers to the users and the advertisers. The wireless network providers can be owner of a wireless network such as, but not limited to, home Wi-Fi owners, restaurants Wi-Fi owners, office Wi-Fi owners, and so forth.

The present disclosure provides a virtual market place for a plurality of wireless network providers for providing their associated networks to a plurality of users in exchange of a fee.

The present disclosure provides an online advertising portal to a plurality of advertisers for advertising their products or services in exchange of a fee or non-monetary benefits.

The present disclosure provides systems and methods for providing free access of a network to plurality of users by presenting a multimedia comprising advertisement to the users. The multimedia may comprise at least one of an audio, a video, a text, and so forth. In some embodiments, the multimedia may be an advertisement of the advertiser.

The present disclosure provides systems and methods for connecting a computing device to a network after playing a multimedia comprising an advertisement of a product or a service. The network may be a wireless network owned by a wireless network provider and the multimedia may be an advertisement of an advertiser. The wireless network provider may charge a fee and the advertiser may pay the fee via a freedom portal.

The present disclosure provides systems and methods for offering a wireless network, by a wireless network provider, as a service to a user in exchange of some money or benefit. This way, the wireless network provider, such as an individual or a company, can benefit by providing an access to the wireless network. The user may not have to pay for accessing the network.

The present disclosure provides systems and methods for connecting a computing device to a wireless network based on the playing of a multimedia on the computing device. A user may select at least one Service Set Identifier (SSID) from a plurality of Service Set Identifiers (SSIDs) for connecting to the network. The SSID may be an identifier or name of the wireless network. The network may be a wireless network.

The present disclosure provides online advertising systems and methods for presenting an advertisement to a user based on a selection of an SSID of a wireless network associated with a wireless network provider. The user may be provided with an access to the wireless network comprising the Internet after playing one or more multimedia associated with the SSID. The SSID may be associated with the multimedia of an advertiser. The one or more multimedia may comprise an advertisement of at least one of a product or a service of the advertiser. The advertiser may be required to pay for advertising by using the wireless network. The wireless network provider may receive a payment for providing an access of the associated wireless network to the user. A freedom portal may act as an interface between the wireless network provider(s) and the advertiser(s).

An embodiment of the present disclosure provides a system for online advertising. The system includes a plurality of wireless network providers, a plurality of advertisers and a freedom portal. The freedom portal comprising a transceiver configured to: receive a request from the plurality of wireless network providers for offering an access of an associated wireless network as a service, wherein each of the associated wireless network comprises a Service Set Identifier (SSID); receive an advertising request from the plurality of advertisers for advertising at least one of an associated service and a product to a plurality of users via a multimedia; and receive a selection of the at least one SSID associated with at least one wireless network from a user for connecting to the at least one wireless network. The freedom portal also includes a payment-managing device configured to: receive a payment from the plurality of advertisers for advertising; make another payment to the plurality of wireless network providers for providing an access of associated wireless network to the plurality of users; and associate an SSID with each of the plurality of advertisers. The freedom portal further comprises a display-managing device configured to present an embedded multimedia along with a connect option on a computing device of the user based on the selection of the at least one SSID associated with the at least one wireless network and the at least one advertiser.

Another embodiment of the present disclosure provides a method for online advertising. The method comprises receiving a request from a plurality of wireless network providers for offering an access of associated wireless networks as a service. Each of the associated wireless networks comprises a Service Set Identifier (SSID). The method further includes receiving an advertising request from the plurality of advertisers for advertising at least one of an associated service and a product to a plurality of users via a multimedia. The method further includes receiving a selection of the at least one SSID associated with at least one wireless network from a user for connecting to the at least one wireless network. The method further includes receiving a payment from the plurality of advertisers for advertising; making another payment to the plurality of wireless network providers for providing an access of associated wireless network to the plurality of users. The method furthermore includes associating an SSID with each of the plurality of advertisers. The method further includes presenting an embedded multimedia along with a connect option on a computing device of the user based on the selection of the at least one SSID associated with the at least one wireless network and at least one advertiser.

Yet another embodiment of the present disclosure provides a freedom portal for online advertising. The freedom portal includes a registration module configured to enable registration of a plurality of wireless network providers and a plurality of advertisers. The plurality of wireless network providers is configured to offer a plurality of wireless networks as a service. The freedom portal further includes a transceiver configured to receive a request from the plurality of wireless network providers for offering an access of an associated wireless network as a service, wherein each of the associated wireless network comprises a Service Set Identifier (SSID); receive an advertising request from the plurality of advertisers for advertising at least one of an associated service and a product to a plurality of users via a multimedia; and receive a selection of the at least one SSID associated with at least one wireless network from a user for connecting to the at least one wireless network. The freedom portal further includes a payment-managing device configured to: receive a payment from the plurality of advertisers for advertising; make another payment to the plurality of wireless network providers for providing an access of the associated wireless network to the plurality of users; enable bidding between the plurality of advertisers and the plurality of wireless network providers; and associate an SSID with each of the plurality of advertisers. The freedom portal furthermore includes a display-managing device configured to present an embedded multimedia along with a connect option on a computing device of the user based on the selection of the at least one SSID associated with the at least one wireless network and at least one advertiser. The freedom portal further includes a connection-managing device configured to connect the computing device to the at least one wireless network based on a selection of the connect option by the user.

According to an aspect of the present disclosure, the display-managing device is further configured to provide a control option to the user along with the embedded multimedia to play, pause, close, rewind, terminate, and forward the multimedia.

According to an aspect of the present disclosure, the payment-managing device is further configured to pay the plurality of wireless network providers based on at least one of a price per day, price per click, and price per action.

According to an aspect of the present disclosure, the embedded multimedia comprises at least one of a website, videos, audios, text messages, microsites, promotional sites, chatbots, payment boxes, shopping carts, popup shops, coupons, e-commerce websites, and restaurants menus associated with the selected at least one SSID.

According to an aspect of the present disclosure, the user is allowed to terminate the playing of the embedded multimedia at any point of time.

According to an aspect of the present disclosure, wherein the display-managing module is further configured to automatically open at least one URL.

According to another aspect of the present disclosure, the display-managing device is further configured to automatically copy a URL related to the embedded multimedia to a clipboard of the computing device; automatically paste the URL in an address bar of a browser on the computing device; and open a webpage associated with the URL on the computing device.

According to another aspect of the present disclosure, the user pastes the URL in the address bar of the browser on the computing device.

According to another aspect of the present disclosure, the plurality of SSIDs are associated with the network.

According to another aspect of the present disclosure, the user selects the at least one SSID from the plurality of SSIDs.

According to another aspect of the present disclosure, an SSID is linked with an advertiser and a wireless network. When a user selects the SSID, an advertisement associated with the advertiser is presented to the user and the user is connected to the wireless network for accessing the Internet.

According to another aspect of the present disclosure, the user accesses the wireless network of the wireless network provider for free.

According to another aspect of the present disclosure, the advertiser pay a fee for playing an associated advertisement on the computing device of the user when the user selects an SSID for connecting to a wireless network. Full money or partial money of the fee may be given to the wireless network provider.

The systems and methods disclosed in the present disclosure are widely applicable to the management of access to network data and media services.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1A is a schematic diagram illustrating an exemplary environment, where various embodiments of the present disclosure may function;

FIG. 1B is a schematic diagram illustrating another exemplary environment, where various embodiments of the present disclosure may function;

FIG. 2 is a block diagram illustrating various system elements of an exemplary freedom portal, in accordance with an embodiment of the present disclosure;

FIGS. 3A-3B is a flowchart illustrating an exemplary method for providing an access of a network to a user by presenting a multimedia, in accordance with an embodiment of the present disclosure; and

FIGS. 4A-4C depicts various interfaces on the computing device for providing an access of a network to a user, in accordance with an embodiment of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

The functional units described in this specification have been labeled as devices. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executables of an identified device need not be physically located together, but may comprise disparate instructions stored in different locations which, when joined logically together, comprise the device and achieve the stated purpose of the device.

Indeed, an executable code of a device could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The freedom portal or system for online advertising may be a software, hardware, firmware, or combination of these. In some embodiments, the freedom portal or the system for online advertising may be present in a cloud network. The term “Freedom Portal” refers to a single device or a combination of multiple devices configured to enable wireless network provider to offer associated wireless network to users and receive monetary and non-monetary benefits in exchange. A user may connect to the wireless network by selecting an SSID for free and without surrendering any personal information. The user may be presented with a multimedia comprising an advertisement of an advertiser. The advertiser may pay for presenting the advertisement to the user. The device or module or the system is further intended to include or otherwise cover all software or computer programs capable of performing the various heretofore-disclosed determinations, calculations, etc., for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

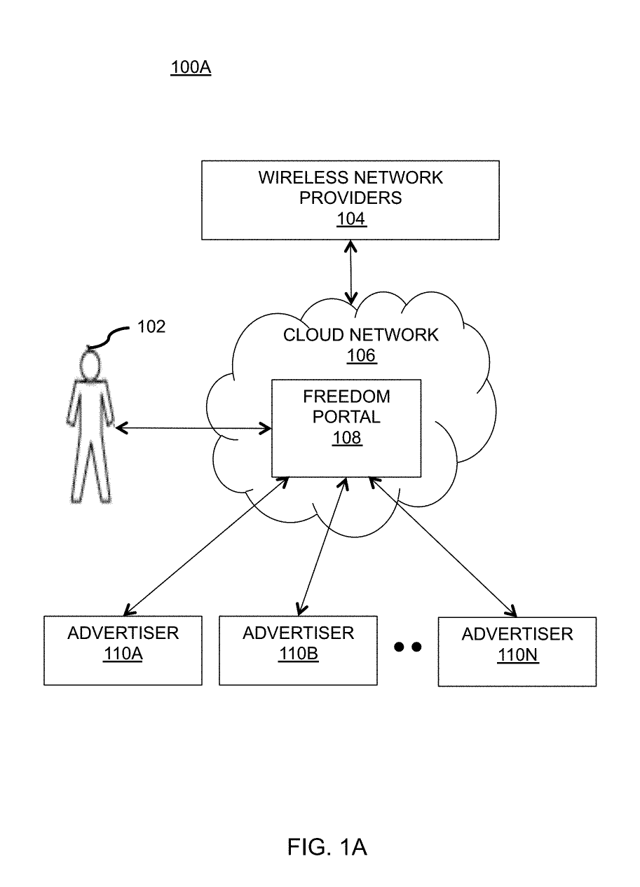

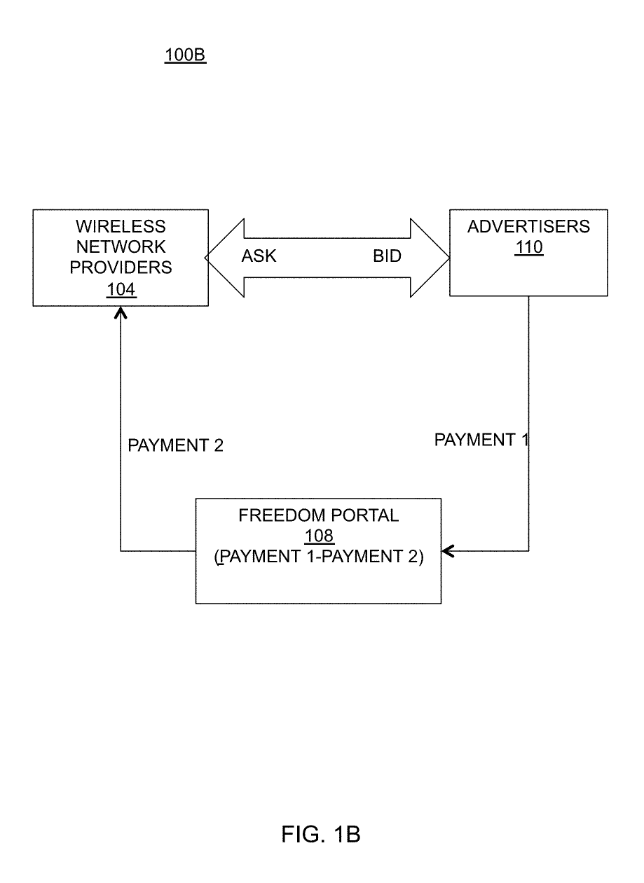

FIG. 1A is a schematic diagram illustrating an exemplary environment 100A, where various embodiments of the present disclosure may function. As shown, the environment 100A primarily includes a user 102, a plurality of wireless network providers 104, a cloud network 106 comprising a freedom portal 108, and a plurality of advertisers 110A-110N. The user 102 may be any individual interested in accessing the wireless network or the Internet. The wireless network providers 104 may be an owner of one or more wireless networks such as a Wi-Fi network. Each of the one or more wireless networks may identified by an associated Service Set Identifier (SSID). The user 102 may view and select at least one SSID from the plurality of SSIDs on an associated computing device. The plurality of SSIDs comprises identifiers of a plurality of wireless networks that are in range of the computing device. Examples of the computing device may include, but are not limited to, a desktop computer, a laptop, a smart phone, a tablet computer, a television, and so forth. The computing device may include a single device capable of communicating, and exchanging one or messages with other devices present in the wireless network. The computing device is also configured to connect to the wireless network such as the Internet.

The SSID may be a primary name associated with a wireless network including home networks and public hotspots. The client devices, such as the computing device, may use the SSID to identify and join wireless networks such as the cloud network 106. In some embodiments, the SSID may be a case sensitive 32 alphanumeric identifier.

The cloud network 106 may include the freedom portal 108. The freedom portal 108 may be a single device or combination of multiple devices comprising hardware, software, firmware, and so forth. The cloud network 106 may be identified by an associated SSID. The plurality of wireless network providers 104 and the plurality of advertisers 110A-110N can register with the freedom portal 108. In some embodiments, the wireless network providers may register with the freedom portal 108 by providing associated information including contact information such as, but not limited to, a name, an age, a phone number, and wireless network details comprising an SSID.

The freedom portal 108 is configured to receive a number of requests from the plurality of wireless network providers 104 for offering an access of their associated wireless network to the user 102 (users). The wireless network providers 104 may be individuals offering the use of their associated wireless network as a service to the user 102 (or users). The wireless network providers 104 may charge a fee for providing an access to their associated wireless networks. In some embodiments, the fee is not charged to the user 102. In some embodiments, the freedom portal 108 pays the fee to the wireless network providers 104. In some embodiments, the plurality of wireless network providers 104 offers an access of their associated wireless network to the user 102 in exchange of some money or other benefits, but the user 102 may not pay for the wireless network. Each of the associated wireless network may comprise a Service Set Identifier (SSID)

The freedom portal 108 is further configured to receive a number of advertising requests from the plurality of advertisers 110A-110N (hereinafter, collectively may be referred as 110) for advertising at least one of an associated service and a product to a plurality of users, such as the user 102, via a multimedia.

The freedom portal 108 is further configured to receive a selection of the at least one SSID associated with at least one wireless network from the user 102 for connecting to the at least one wireless network. The user 102 can see a plurality of SSIDs of a plurality of networks that are available or in range of the computing device. The user 102 can select at least one of the plurality of SSIDs on the computing device. The freedom portal 108 may manage or control an access to a plurality of wireless networks associated with the plurality of wireless network providers 104. The freedom portal 108 may receive the selection of the at least one SSID from the computing device.

The freedom portal 108 is further configured to receive a payment from the plurality of advertisers 110A-110N for advertising. In some embodiments, the freedom portal 108 is further configured to pay the plurality of wireless network providers based on at least one of a price per day, price per click, and price per action by a user on a multimedia played on the computing device of the user. The freedom portal 108 is further configured to make another payment to the plurality of wireless network providers 104 for providing an access of associated wireless network to the plurality of users (or the user 102). The freedom portal 108 is further configured to associate an SSID with each of the plurality of advertisers 110. In some embodiments, one SSID may be associated with more than one advertiser. The freedom portal 108 is further configured to present an embedded multimedia along with a connect option on the computing device of the user 102 based on the selection of the at least one SSID associated with the at least one wireless network and the at least one advertiser such as the advertiser 110A.

In some embodiments, the wireless network providers 104 and the advertisers 110 may interact and negotiate terms and conditions for payment and service etc. via the freedom portal 108. In some embodiments, the freedom portal 108 is further configured to enable bidding between the plurality of advertisers 110A-110N and the plurality of wireless network providers 104.

The freedom portal 108 is further configured to present an embedded multimedia along with a connect option on a computing device of the user 102 based on the selection of the at least one SSID associated with the at least one wireless network and the at least one advertiser 110A. The freedom portal 108 may search for a multimedia corresponding to the selected at least one SSID and present on the computing device. The multimedia may be a pre-stored multimedia at the freedom portal 108 or may be fetched in real-time from a third party server by the freedom portal 108. The multimedia may be selected based on one or more parameters, including but are not limited to, a location, the SSID, the advertiser linked to the SSID, and so forth. In some embodiments, the embedded multimedia comprises at least one of a website, videos, audios, text messages, microsites, promotional sites, chatbots, payment boxes, shopping carts, popup shops, coupons, e-commerce websites, and restaurants menus associated with the selected at least one SSID. The multimedia may be played on the computing device automatically. The user 102 may be provided with a control option to the user along with the embedded multimedia to play, pause, close, rewind, and forward the multimedia. In some embodiments, the user 102 may forward or rewind the multimedia. Further, the freedom portal 108 may present a “Connect to Internet” option along with the multimedia on the computing device. On completion of the multimedia, the user 102 may select the “Connect to Internet” option. In some embodiments, the user 102 may terminate the multimedia and just connect to the wireless network. Based on the selection of the “Connect to Internet” option, the freedom portal 108 may grant an access of the cloud network 106 to the user 102.

The freedom portal 108 is further configured to connect the computing device to the at least one wireless network based on a selection of the connect option by the user 102. The freedom portal 108 is further configured to open at least one webpage associated with at least one uniform resource locator (URL) related to the embedded multimedia on the computing device.

In some embodiments, the freedom portal 108 presents a uniform resource locator (URL) or a webpage address related to the multimedia to the user 102 on the computing device. In other embodiments, the freedom portal 108 presents multiple URLs related to the multimedia and/or the at least one SSID to the user 102 on the computing device. The URL may a web address of a website related to the multimedia associated with the selected at least one SSID. In some embodiments, the freedom portal may present or display more than one URL related to the selected at least one SSID. Further, the URLs may be presented in multiple white boxes on the computing device. In some embodiments, the user 102 copies and pastes the URL or at least one preferred URL of the multiple URLs in a browsing application on the computing device for accessing the website associated with the URL. In some embodiments, the freedom portal 108 provides access of the cloud network 106 to the user 102 when the user 102 selects the “Connect to Internet” option after finishing of the multimedia on the computing device. In some embodiments, the computing device is automatically connected to the cloud network 106 as soon the multimedia finishes. In some embodiments, the user 102 may opt for not exploring the website linked to the URL related to the multimedia.

Further, in some embodiments, the freedom portal 108 may automatically copy the URL or at least one of the multiple URLs in a clipboard of the computing device when the user 102 selects the “Connect to Internet” option. Further, the freedom portal 108 may automatically open the webpage linked to the URL or the at least one URL after connecting the computing device of the user 102 to the Internet/network. Then, the user 102 may continue using or exploring the cloud network 106 (i.e. the Internet). Therefore, the user 102 is given two-tier selection freedom, one for the selection of the SSID and one for the selection of the related URL in the white boxes. The user 102 can access the network without surrendering his/her personal information.

In some embodiments, the freedom portal 108 is configured to enable registration of the plurality of wireless network providers 104 and the plurality of advertisers 110.

FIG. 1B is a schematic diagram illustrating an exemplary environment 100B, where various embodiments of the present disclosure may function. As shown, the environment 100B primarily includes the plurality of wireless network providers 104, the freedom portal 108, and the plurality of advertisers 110A-110N (or 110). The advertisers 110 may ask the wireless network providers 104 if they can play an advertisement while providing an access of an associated wireless network to the user 102. The advertisers 110 may directly or indirectly ask the wireless network providers 104 via the freedom portal 108. In some embodiments, the advertisers 110 may bid for advertising their associated services and products via multimedia through the freedom portal 108.

The freedom portal 108 may act as an interface between the advertisers 110 and the wireless network providers 104 while bidding, and assigning SSIDs to a particular advertiser of the advertisers 110. The freedom portal 108 may assign an SSID with each of the advertisers 110. The user 102 can select an SSID for connecting to at least one wireless network. Then the freedom portal plays an advertisement on a computing device of the user 102 assigned to the SSID. The freedom portal 108 may play the advertisement of the advertisers 110 according to the selection of the SSID.

Further, the advertisers 110 may pay a “Payment 1” to the freedom portal for advertising the products or/and services on a particular wireless network provider of the wireless network providers 104. The “Payment 1” may be in terms of monetary or non-monetary benefits. The freedom portal 108 may make a “Payment 2” to the particular wireless network provider of the wireless network providers 104. The “Payment 2” may be in terms of monetary or non-monetary benefits. In some embodiments, the freedom portal 108 may pay the wireless networks s pay per click, per day, per action and so forth. Further the freedom portal 108 may keep some money from “Payment 1” e.g., “Payment 1-Payment 2” for providing the interfacing service to the advertisers 110 and the wireless network providers 104.

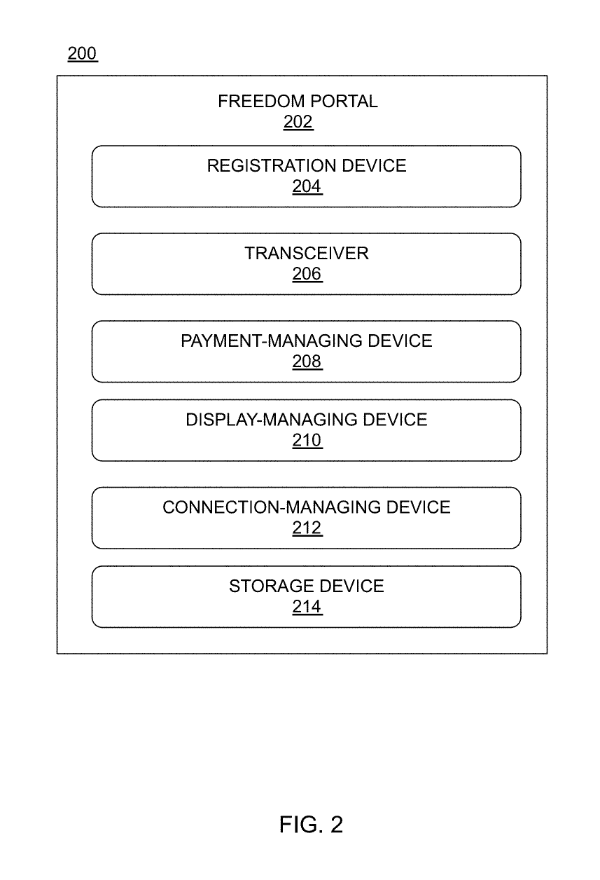

FIG. 2 is a block diagram 200 illustrating various system elements of an exemplary freedom portal 202, in accordance with an embodiment of the present disclosure. As shown, the freedom portal 202 may include a registration device 204, a transceiver 206, a payment-managing device 208, a display-managing device 210, a connection-managing device 212, and a storage device 214. As discussed with reference to the FIGS. 1A-1B, the freedom portal 202 may receive requests from the wireless network providers 104, the user 102, and the advertisers 110. The wireless network providers 104 may provide their associated wireless network availability to the freedom portal 202. The advertisers 110 may send advertising requests to the freedom portal 202 for advertising at least one of a product or service. Each of a plurality of wireless networks has an associated SSID. Further, the freedom portal 202 is configured to link at least one SSID with at least one advertiser of the advertisers 110. Further, the freedom portal 202 may be an online platform or interface between the advertisers 110 and the wireless network providers 104. Further, on a computing device, the user 102 may select at least one Service Set Identifier (SSID) from one or more SSIDs for connecting to a wireless network associated with the SSID and owned by at least one wireless network provider.

The freedom portal 202 may be a single device or a combination of multiple devices configured to enable the user 102 to connect to the wireless network by selecting an SSID and without a need of surrendering any of his/her personal information. The freedom portal 202 enables a user to connect to the wireless network and also gives him/her the freedom to select the SSID and a related URL associated with a multimedia.

The wireless network providers 104 and the advertisers 110 may register with the freedom portal 202. The registration module 204 may be configured to register the wireless network providers 104 and the advertisers 110 with the freedom portal 202.

The transceiver 206 may be configured to receive a selection of the at least one Service Set Identifier (SSID) associated with a wireless network from the user 102. Further, the transceiver 206 is configured to receive a request from the plurality of wireless network providers 104 for offering an access of an associated wireless network as a service. Each of the associated wireless network comprises a Service Set Identifier (SSID). The transceiver 206 may be configured to receive an advertising request from the plurality of advertisers 110 for advertising at least one of an associated service and a product to a plurality of users such as the user 102 via a multimedia. The transceiver 206 is also configured to a selection of the at least one SSID associated with at least one wireless network from the user 102 for connecting to the at least one wireless network.

The SSID may be a primary name associated with the cloud network 106 comprising a wireless network. In some embodiments, the plurality of SSIDs is associated with the plurality of networks. The computing device may use the SSID to identify and join wireless networks. In some embodiments, the SSID may be a case sensitive 32 alphanumeric identifier. The transceiver 206 may be a single device or a combination of multiple devices comprising at least one of a hardware, software, firmware, and combination of these.

The payment-managing device 208 may be configured to receive a payment from the plurality of advertisers for advertising. The payment-managing device 208 may be configured to make another payment to the plurality of wireless network providers 104 for providing an access of associated wireless network to the plurality of users like the user 102. The payment-managing device 208 may be configured to associating an SSID with each of the plurality of advertisers 110.

The display-managing device 210 may be configured to present an embedded multimedia along with a connect option on the computing device of the user 102 based on the selection of the at least one SSID. The embedded multimedia may include at least one advertisement associated with the selected at least one SSID and linked to the advertiser. The connect option may be a “Connect to Internet” option. In some embodiments, the display-managing device 210 may provide a play option for enabling the user 102 to forward, pause, rewind, and play the multimedia. In some embodiments, the user 102 is allowed to terminate the playing of the embedded multimedia at any point of time. Further, after terminating the user 102 may select the “Connect to Internet” option for connecting to the wireless network.

In some embodiments, the display-managing device 210 may also be configured to present the one or more URLs related with the embedded multimedia to the user 102 in multiple white boxes. The user 102 may select and copy/paste the URL (or a preferred URL from the one or more URLs) in the address bar of the browser on the computing device. In some embodiments, the display-managing device 210 may also be configured to open the at least one webpage associated with the at least one URL of the one or more URLs based on a selection of the at least one URL by the user 102.

In some embodiments, the display-managing device 210 is configured to automatically copy the one or more URLs related to the embedded multimedia in a clipboard of the computing device. The display-managing device 210 may also be configured to automatically paste the one or more URLs in an address bar of the browser or browsing application on the computing device. The display-managing device 210 may also be configured to open a webpage or website associated with the one or more URLs on the computing device. Examples of the browser or the browsing application may include, but are not limited to, Mozilla, Safari, Opera, Internet Explorer, Google Chrome, and so forth. The display-managing device 210 may include hardware, software, firmware, and combination of these.

The connection-managing device 212 may be configured to connect the computing device to the wireless network based on a selection of the connect option by the user 102. The connection-managing device 212 may include hardware, software, firmware, and combination of these. The connection-managing device 212 may also be configured to open at least one webpage associated with at least one uniform resource locator (URL) related to the embedded multimedia on the computing device.

In some embodiments, the display-managing device 210 is further configured to provide the play option on the computing device for controlling playing of the embedded multimedia.

In some embodiments, the connection-managing device 212 is configured to connect the computing device to the cloud network 106 after completion of the embedded multimedia.

The display-managing device 210 is further configured to open at least one webpage associated with at least one uniform resource locator (URL) related to the multimedia and/or SSID on the computing device.

The storage device 214 is configured to store identity information of the users, a plurality of wireless networks, SSIDs, URLs, multimedia, location information, identity and contact information of the wireless network providers 104, identity and contact information of the advertisers 110, and so forth.

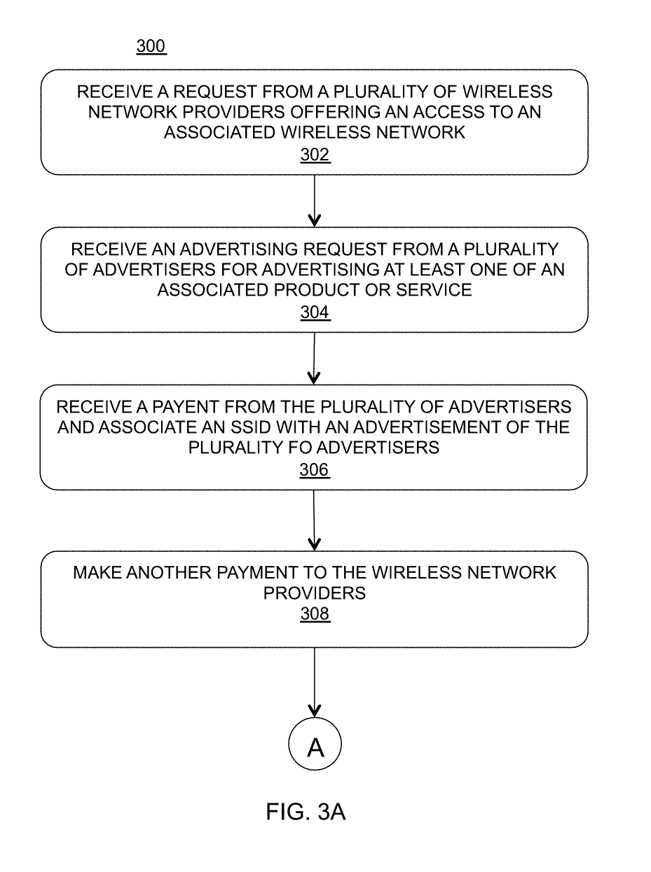

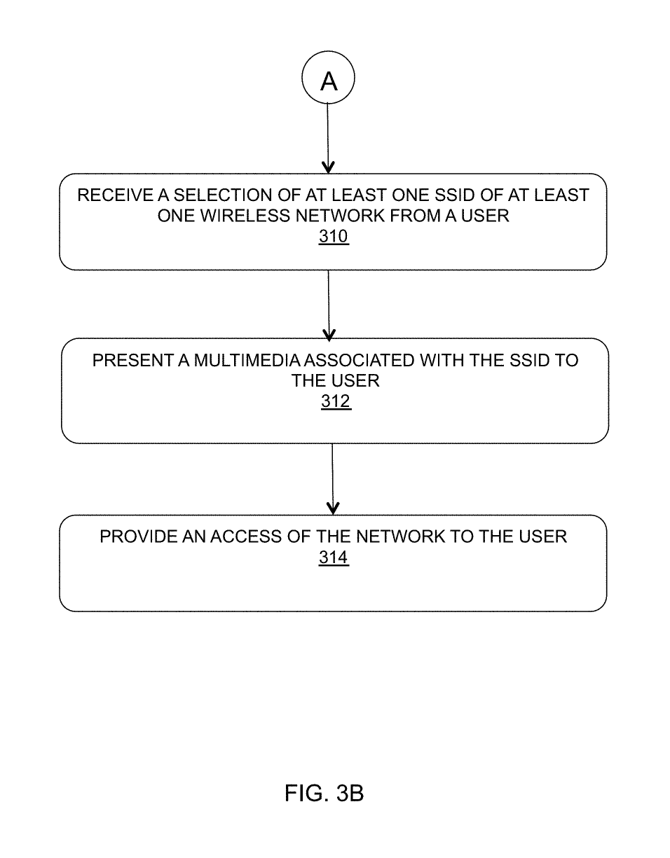

FIGS. 3A-3B is a flowchart illustrating an exemplary method for providing an access of a network to a user by presenting a multimedia, in accordance with an embodiment of the present disclosure. As discussed with reference to FIG. 1, the user 102 may access the computing device for connecting to the wireless network. Further, as shown in the FIG. 2, the freedom portal 202 may present a multimedia to the user 102 before connecting to the wireless network. Further, a wireless network provider being the owner of the wireless network may receive some monetary or non-monetary benefits out of it.

At step 302, request for a plurality of wireless network providers for offering an access to an associated wireless network is received. The transceiver 206 may receive the request from the wireless network providers (See 104 in FIG. 1A). The registration module 204 may register the wireless network providers with the freedom portal 202.

Then at step 304, advertising request(s) from a plurality of advertisers for advertising at least one of an associated service and a product to a plurality of users via a multimedia is received by the transceiver 206. The registration module 204 may register the advertisers with the freedom portal 202.

At step 306, the payment-managing device 208 may receive a payment from the plurality of the advertisers and may associate an SSID of a wireless network of a plurality of wireless networks with each of the plurality of advertisers.

At step 308, the payment-managing device 208 may make another payment to the plurality of wireless network providers for providing an access of associated wireless network to the plurality of users. In some embodiments, the payment-managing device 208 is configured to pay the plurality of wireless network providers based on at least one of a price per day, price per click, and price per action. The action may refer to an action on the multimedia by the user such as, but not limited to, a click, a purchase of an item or service, and so forth. Further, the payment and the another payment may be same. Alternatively the payment and the another payment may be different.

At step 310, the transceiver 206 may receive a selection of at least one SSID from the user. The user may select the at least one SSID on a computing device.

Then at step 312, a multimedia associated with the SSID is presented to the user. As the SSID is linked to some advertiser, therefore, the display-managing module 210 may present a multimedia associated with the advertiser to the user. In some embodiments, a connect option and/or one or more URLs are also presented to the user along with the multimedia. The multimedia can be, but not limited to, a website, videos, audios, text messages, microsites, promotional sites, chatbots, payment boxes, shopping carts, popup shops, coupons, e-commerce websites, and restaurants menus associated with the selected at least one SSID. The display-managing module 210 is further configured to automatically open at least one URL. The user may pause, rewind, forward, play, or terminate the multimedia. The multimedia may comprise at least one of an audio, a video and text. The multimedia can be an advertisement of a product or service. In some embodiments, the display-managing device 210 presents the multimedia onto the computing device. The user is also presented with a forward/rewind option or a play option for forwarding or rewinding or playing/pausing/terminating the multimedia. The display-managing device 210 may also present a “Connect to Internet” option to the user on the computing device. The user may select the “Connect to Internet” option on the computing device.

Thereafter, at step 314, the connection-managing module 212 is configured to connect and provide an access of the wireless network to the user. In some embodiments, the user is given the access of the wireless network when the user terminates the multimedia. In some embodiments, the display-managing device 210 displays one or more URLs related to the multimedia on the computing device. For example, the multimedia may be an advertisement of a product like bag, watch, etc., and the URLs may be link to open website(s) for shopping the product. In some embodiments, the connection-managing device 212 provides the access of the wireless network to the user 102 by connecting the computing device to the wireless network such as the Internet.

In some embodiments, the connection-managing device 212 opens a webpage related to the multimedia by automatically copying and pasting a URL associated with the webpage in a browser on the computing device. The user may explore the webpage but it is not mandatory for the user to explore the webpage for connecting to the Internet. In some embodiments, the user may be presented with the URL or one or more URLs in multiple white boxes. Further, the display-managing device 210 may open the webpage based on the selection of the URL by the user.

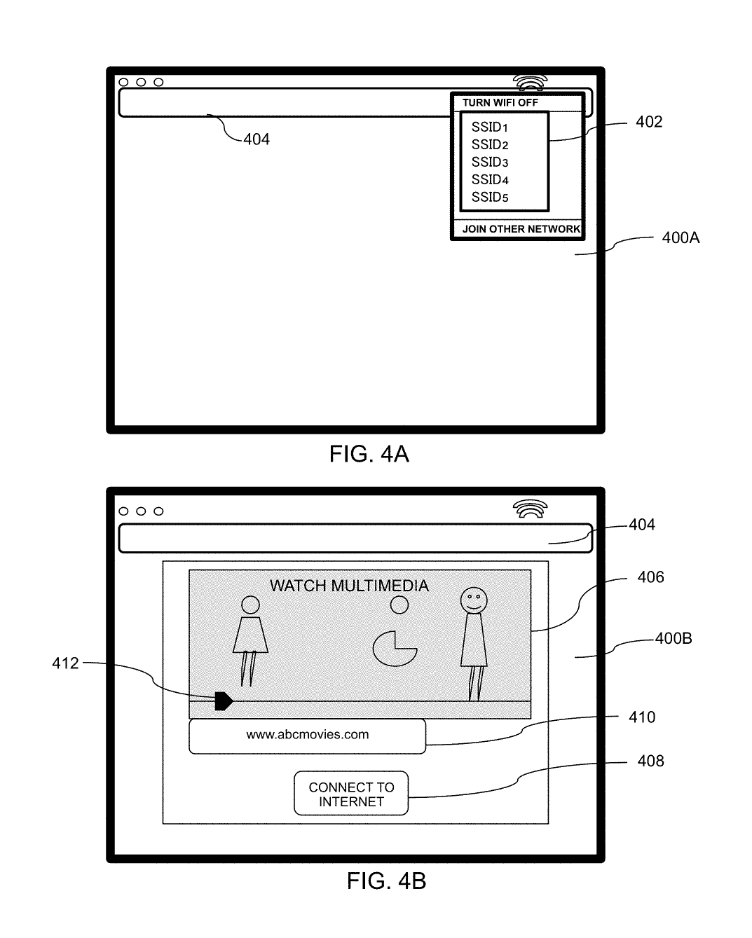

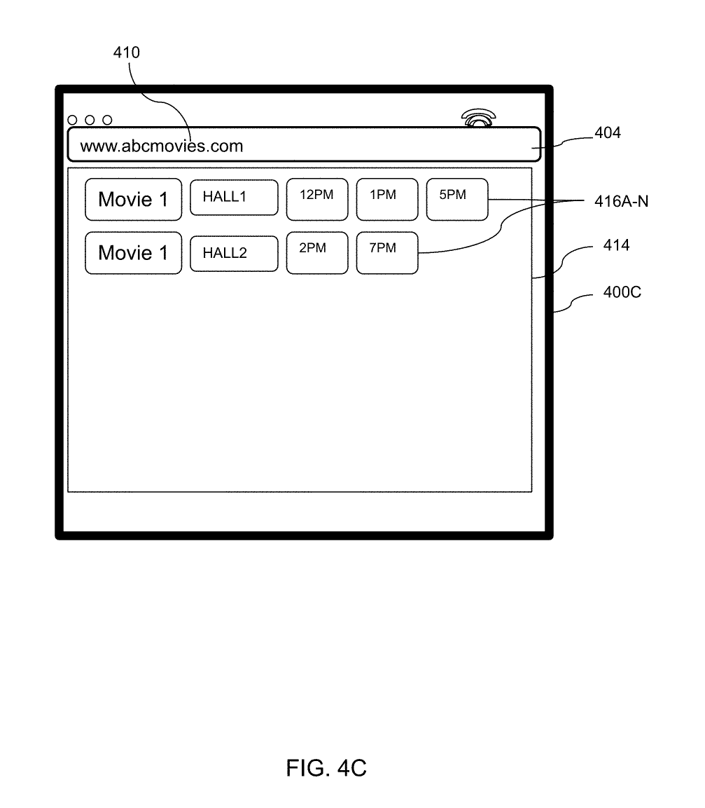

FIGS. 4A-4C shows various interfaces 400A, 400B, and 400C for providing an access of a network to a user on a computing device, in accordance with an embodiment of the present disclosure. As discussed with reference to FIG. 1, the interfaces 4A-4C may be graphical user interfaces on the computing device via which the user 102 may interact with the computing device to connect to the cloud network 106 to explore the Internet. As discussed with reference to FIGS. 1A-1B, the wireless network providers 104 may offer their associated wireless networks to the user 102. When the user selects at least one SSID for connecting to at least one wireless network, the user 102 may be presented with a multimedia as shown in FIG. 4A. The multimedia may be an advertisement associated with an advertiser of the advertisers 110.

As shown in FIG. 4A, the user 102 may view a list 402 of a plurality of SSIDs associated with a plurality of networks on the interface 400A on computing device. Each of the plurality of SSIDs of the list 402 may be a unique identifier associated with the plurality of networks. The user 102 may select at least one SSID for connecting to at least one network of the plurality of networks. The SSID may be an alphanumeric identifier or a name of the at least one network or a wireless network. As discussed with reference to FIG. 2, the freedom portal 202 may receive the selection of the at least one SSID from the computing device. In some embodiments, the transceiver 206 receives the selection of the at least one SSID from the computing device. The interface 400A also includes a browser or a browsing application 404. The browser 404 enables the user 102 to paste a uniform resource locator for exploring a website.

Turning now to FIG. 4B the interface 400B is shown. The freedom portal 202 may search for a matching multimedia 406 related to the selected SSID. The freedom portal 202 presents the matching multimedia 406 along with a “Connect to Internet” option 408 to the user 102 via the interface 400B on the computing device. The user 102 may also control such as forward, rewind, play, or pause the multimedia by moving a control/play option 412 on the interface 400B. The user 102 needs not to watch the multimedia; the user 102 can switch to connect to the Internet option for connecting to the Internet without any delay. The freedom portal 202 via the interface 400B also presents a URL 410 linked to a website or a webpage related to the multimedia to the user 102. In some embodiments, the display-managing device 210 presents the multimedia 406, the “Connect to Internet” option 408, the URL 410, and the control/play option 412 on the interface 400B. The user 102 can select the “Connect to Internet” option 408 after the completion of the multimedia 406. The connection-managing device 212 connects the computing device to the Internet. In some embodiments, the freedom portal 202 automatically copies the URL 410 and pastes in the browser 404 for opening the website related to the multimedia 406 on the computing device. In alternate embodiments, the user 102 copies the URL 410 and pastes the URL 410 in the browser 404.

FIG. 4C depicts the interface 400C. The freedom portal 202 or the display-managing device 210 opens a website or webpage 414 associated with the URL 410 via the interface 400C on the computing device. For example, the multimedia 406 may be an audio/video clip of a movie 1 promotion, and the URL 410 may be a link for webpage for booking the movie tickets for the movie 1. The webpage 414 may include multiple booking options 416A-N for booking the movie 1. The user 102 may either proceed with the booking of the movie 1 by selecting at least one of the booking options 416A-N or may explore the Internet as per his/her preference. The user 102 may be free to explore the Internet and may not be mandatory for the user 102 to book the tickets or explore the URL 410. Hence, the freedom portal 202 provides freedom to the user 102 to connect to the Internet without surrendering his/her personal information.

The present disclosure enables various wireless network owners to provide their wireless networks such as Wi-Fi as a service and earn money or other benefits. The wireless network owners may share their network with other users and may get paid from the freedom portal for doing so.

The present disclosure enables various advertisers to advertise their services and products via the freedom portal. The advertisers may pay a fee for the same. Further, the freedom portal may act as a mediator between the wireless network providers and the advertisers. Further, the users may use the wireless network of the wireless network providers for almost free and without surrendering his/her personal information. The freedom portal may also gain from this my charging the advertiser some fee.

The present disclosure enables a user to connect to the Internet or a network without disclosing or surrendering any personal information.

The present disclosure may also enable a user to explore websites related to the SSID of the network. In some embodiments, the SSID may be in accordance with the network.

The present disclosure may aware the user about a product/service/entertainment service and generate an interest of the user in the same. The user is free to decide whether the user wants to proceed to view more details about the product/service/entertainment service advertised via a multimedia by selecting one or more URLs displayed on the computing device.

The present disclosure may also enable the user to select an SSID of a preferred network and a preferred URL from a list of a plurality of URLs related to the preferred network. The user is given freedom to select the SSID and URL of his/her own choice.

It will be understood that the devices and the databases referred to in the previous sections are not necessarily utilized together method or system of the embodiments. Rather, these devices are merely exemplary of the various devices that may be implemented within a computing device or the server device, and can be implemented in exemplary another devices, and other devices as appropriate, that can communicate via a network to the exemplary server device.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above-disclosed and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

What is claimed is:

1. A system for online advertising comprising:
a plurality of wireless network providers;
a plurality of advertisers;
a freedom portal comprising:
a transceiver configured to:
receive a request from the plurality of wireless network providers for offering an access of an associated wireless network as a service, wherein each of the associated wireless network comprises a Service Set Identifier (SSID);
receive an advertising request from the plurality of advertisers for advertising at least one of an associated service and a product to a plurality of users via a multimedia; and
receive a selection of the at least one SSID associated with at least one wireless network from a user for connecting to the at least one wireless network;
a payment-managing device configured to:
receive a payment from the plurality of advertisers for advertising;
make another payment to the plurality of wireless network providers for providing an access of associated wireless network to the plurality of users; and
associating an SSID with each of the plurality of advertisers; and
a display-managing device configured to present an embedded multimedia along with a connect option on a computing device of the user based on the selection of the at least one SSID associated with the at least one wireless network and the at least one advertiser.

2. The system of claim 1, wherein the freedom portal further comprising a connection-managing device configured to:
connect the computing device to the at least one wireless network based on a selection of the connect option by the user; and
open at least one webpage associated with at least one uniform resource locator (URL) related to the embedded multimedia on the computing device.

3. The system of claim 1, wherein the payment managing module is further configured to enable bidding between the plurality of advertisers and the plurality of wireless network providers.

4. The system of claim 1 further comprising a registration module configured to enable registration of the plurality of wireless network providers and the plurality of advertisers.

5. The system of claim 1, wherein the display-managing device is further configured to provide a control option to the user along with the embedded multimedia to play, pause, close, rewind, and forward the multimedia.

6. The system of claim 1, wherein the payment-managing device is further configured to pay the plurality of wireless network providers based on at least one of a price per day, price per click, and price per action.

7. The system of claim 1, wherein the embedded multimedia comprises at least one of a website, videos, audios, text messages, microsites, promotional sites, chatbots, payment boxes, shopping carts, popup shops, coupons, e-commerce websites, and restaurants menus associated with the selected at least one SSID.

8. The system of claim 1, wherein the display-managing module is further configured to automatically open at least one URL.

9. A method for online advertising, comprising:
receiving a request from a plurality of wireless network providers for offering an access of associated wireless networks as a service, wherein each of the associated wireless network comprises a Service Set Identifier (SSID);
receiving an advertising request from a plurality of advertisers for advertising at least one of an associated service and a product to a plurality of users via a multimedia;
receiving a selection of the at least one SSID associated with at least one wireless network from a user for connecting to the at least one wireless network;
receiving a payment from the plurality of advertisers for advertising;
making another payment to the plurality of wireless network providers for providing an access of associated wireless network to the plurality of users;
associating an SSID with each of the plurality of advertisers; and
presenting an embedded multimedia along with a connect option on a computing device of the user based on the selection of the at least one SSID associated with the at least one wireless network and at least one advertiser.

10. The method of claim 9 further comprising:
connecting the computing device to the at least one wireless network based on a selection of the connect option by the user; and
opening at least one webpage associated with at least one uniform resource locator (URL) related to the embedded multimedia on the computing device.

11. The method of claim 9 further comprising enabling bidding between the plurality of advertisers and the plurality of wireless network providers.

12. The method of claim 9 further comprising providing a control option to the user along with the embedded multimedia to play, pause, close, rewind, and forward the multimedia.

13. The method of claim 9 further comprising registration of the plurality of wireless network providers and the plurality of advertiser with a freedom portal.

14. The method of claim 9 further comprising to pay the plurality of wireless network providers based on at least one of a price per day, price per click, and price per action.

15. The method of claim 9, wherein the embedded multimedia comprises at least one of a website, videos, audios, text messages, microsites, promotional sites, chatbots, payment boxes, shopping carts, popup shops, coupons, e-commerce websites, and restaurants menus associated with the selected at least one SSID.

16. The method of claim 9 making another payment to the plurality of wireless network providers further comprising paying the plurality of wireless network providers based on at least one of a price per day, price per click, and price per action.

17. A freedom portal for online advertising, comprising:
a registration module configured to enable registration of a plurality of wireless network providers and a plurality of advertisers, wherein the plurality of wireless network providers are configured to offer a plurality of wireless networks as a service;
a transceiver configured to:
receive a request from the plurality of wireless network providers for offering an access of an associated wireless network as a service, wherein each of the associated wireless network comprises a Service Set Identifier (SSID);
receive an advertising request from the plurality of advertisers for advertising at least one of an associated service and a product to a plurality of users via a multimedia; and
receive a selection of the at least one SSID associated with at least one wireless network from a user for connecting to the at least one wireless network;
a payment-managing device configured to:
receive a payment from the plurality of advertisers for advertising;
make another payment to the plurality of wireless network providers for providing an access of the associated wireless network to the plurality of users;
enable bidding between the plurality of advertisers and the plurality of wireless network providers; and
associate an SSID with each of the plurality of advertisers;
a display-managing device configured to present an embedded multimedia along with a connect option on a computing device of the user based on the selection of the at least one SSID associated with the at least one wireless network and at least one advertiser; and
a connection-managing device configured to connect the computing device to the at least one wireless network based on a selection of the connect option by the user.

18. The freedom portal of claim 17, wherein the payment-managing device is further configured to pay the plurality of wireless network providers based on at least one of a price per day, price per click, and price per action.

19. The freedom portal of claim 17, wherein the display-managing device is further configured to provide a control option to the user along with the embedded multimedia to play, pause, close, rewind, and forward the multimedia.

20. The freedom portal of claim 17, wherein the embedded multimedia comprises at least one of a website, videos, audios, text messages, microsites, promotional sites, chatbots, payment boxes, shopping carts, popup shops, coupons, e-commerce websites, and restaurants menus associated with the selected at least one SSID.
